(19) United States
(12) Patent Application Publication
(10) Pub. No.: US 2009/0099886 A1
(43) Pub. Date: Apr. 16, 2009

(54) System and method for performance-based payload management

(75) Inventors: Jonny Ray Greiner, Dunlap, IL (US); Yang Liu, Dunlap, IL (US); Bhavin Jagdishbhai Vyas, Edwards, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/974,371

(22) Filed: Oct. 12, 2007

(51) Int. Cl. G06Q 10/00

(52) U.S. Cl. 705/7

(57) ABSTRACT

A method for managing machine payload based on haul road conditions comprises collecting performance data associated with a machine operating in a work environment and determining an actual total effective grade of the machine based on the collected performance data. The total effective grade is compared with a target total effective grade value, and total effective grade associated with a plurality of payload levels may be simulated if the actual total effective grade is not within a threshold range of the target total effective grade value. At least one of the plurality of payload levels that causes the simulated total effective grade to fall within the threshold range of the target total effective grade value is identified.

### TECHNICAL FIELD

The present disclosure relates generally to transportation management and, more particularly, to a system and method for performance-based payload management.

### BACKGROUND

Rolling resistance refers to the force required to keep a tire moving at a constant speed. Stated differently, rolling resistance refers to the force that must be overcome to roll a tire. In many work environments, particularly those that involve the operation of wheeled machines to transport goods or materials from one location to another, limiting rolling resistance of the machines is an important part of improving the efficiency and productivity of the work environment. For example, reducing the rolling resistance associated with a machine reduces the amount of energy that is required to move the machine and, therefore, increases the fuel efficiency of the machine. Furthermore, reducing the rolling resistance may reduce stress and strain forces on machine drive train components, which may prolong drive train lifespan and reduce costs associated with premature component failure.

Some factors that affect rolling resistance include physical features of the machine or its constituent components, the surface of the road or path upon which the machine is traveling, and/or characteristics of the machine/road interface. For example, rolling resistance may depend on physical features of the machine such as the machine weight (including payload), the machine speed, and tire pressure and size; physical features of the haul road such as road surface density, coefficient of friction, road grade; and/or characteristics of the machine/road interface such as slippage of the machine tires on the roadway surface. Of the factors identified above, one of the quickest and least expensive ways to control machine rolling resistance is by regulating the payload of the machine. Thus, in an effort to improve the health, longevity, and/or efficiency of one or more machines and to increase the efficiency of a roadway, a method for monitoring machine rolling resistance and adjusting the payload level for the machine to regulate the monitored rolling resistance may be required.

One conventional method for monitoring machine resistance operating on a road segment is described in U.S. Pat. No. 5,817,936 (“the '936 patent”) to Schricker. The '936 patent describes a method for detecting a change in the condition of a road by sensing a plurality of parameters from one or more machines traveling along the road. The sensed parameters may be used to calculate a resistance factor for each of the one or more machines and determine an average resistance factor for the fleet of machines. If the average resistance factor exceeds a threshold level, a change (i.e., deficiency or fault) in the road segment may be identified and/or corrected.

Although some conventional methods, such as the method described in the '936 patent, may enable detection of changes in road conditions based on changes in resistance factors for a fleet of machines, they may be limited in certain situations. For example, while the system of the '936 patent may be configured to detect changes in machine rolling resistance values and, in some cases, identify and correct irregularities in the haul road to reduce the rolling resistance, it may not prescribe adjustments to payload of individual machines or groups of machines to reduce rolling resistance. However, correcting irregularities in haul road segments typically requires re-grading or repairing the haul road segment, which may require shutting down the haul road to complete the repair(s), resulting in lost revenue during the repair period. In many cases, the amount of revenue lost outweighs the improvement in efficiency associated with the reduction in rolling resistance. Accordingly, repair and improvements to the haul road to reduce machine rolling resistance are often delayed until the cost can be justified. As a result, many of the machines may be required to operate despite increased rolling resistance, which may cause excessive stress and strain on drive train components, potentially resulting in decreased lifespan of the components.

The presently disclosed system and method for performance-based payload management are directed toward overcoming one or more of the problems set forth above.

### SUMMARY

In accordance with one aspect, the present disclosure is directed toward a method for managing machine payload based on haul road conditions. The method may comprise collecting performance data associated with a machine operating in a work environment and determining a total effective grade of the machine based on the collected performance data. The total effective grade may be compared with a target total effective grade value, and machine total effective grade associated with a plurality of payload levels may be simulated if the total effective grade is not within a threshold range of the target total effective grade value. At least one of the plurality of payload levels that causes the simulated total effective grade to fall within the threshold range of the target total effective grade value may be identified.

According to another aspect, the present disclosure is directed toward a computer-readable medium for use on a computer system, the computer-readable medium including computer-executable instructions for performing a method for managing machine payload based on haul road conditions. The method may comprise collecting performance data associated with a machine operating in a work environment and determining a total effective grade of the machine based on the collected performance data. The total effective grade may be compared with a target total effective grade value, and machine total effective grade associated with a plurality of payload levels may be simulated if the total effective grade is not within a threshold range of the target total effective grade value. At least one of the plurality of payload levels that causes the simulated total effective grade to fall within the threshold range of the target total effective grade value may be identified.

In accordance with yet another aspect, the present disclosure is directed toward a haul route management system. The haul route management system includes a condition monitoring system in data communication with a machine operating in a work environment and configured to collect performance data associated with a machine operating in a work environment and monitor a current total effective grade of the machine based on the performance data. The haul route management system may also include a performance simulator communicatively coupled to the condition monitoring system. The performance simulator may be configured to compare the total effective grade with a target total effective grade value. The performance simulator may then simulate machine total effective grade associated with a plurality of payload levels if the total effective grade is not within a threshold range of the target total effective grade value. The performance simulator may also be configured to identify at least one of the plurality of payload levels that causes the simulated total effective grade to fall within the threshold range of the target total effective grade value.

### BRIEF DESCRIPTION OF THE DRAWINGS

FIG. 1 illustrates an exemplary work environment consistent with the disclosed embodiments;

FIG. 2 provides a schematic diagram illustrating certain components associated with the work environment of FIG. 1; and

FIG. 3 provides a flowchart depicting an exemplary method for performance-based payload management, consistent with the disclosed embodiments.

### DETAILED DESCRIPTION

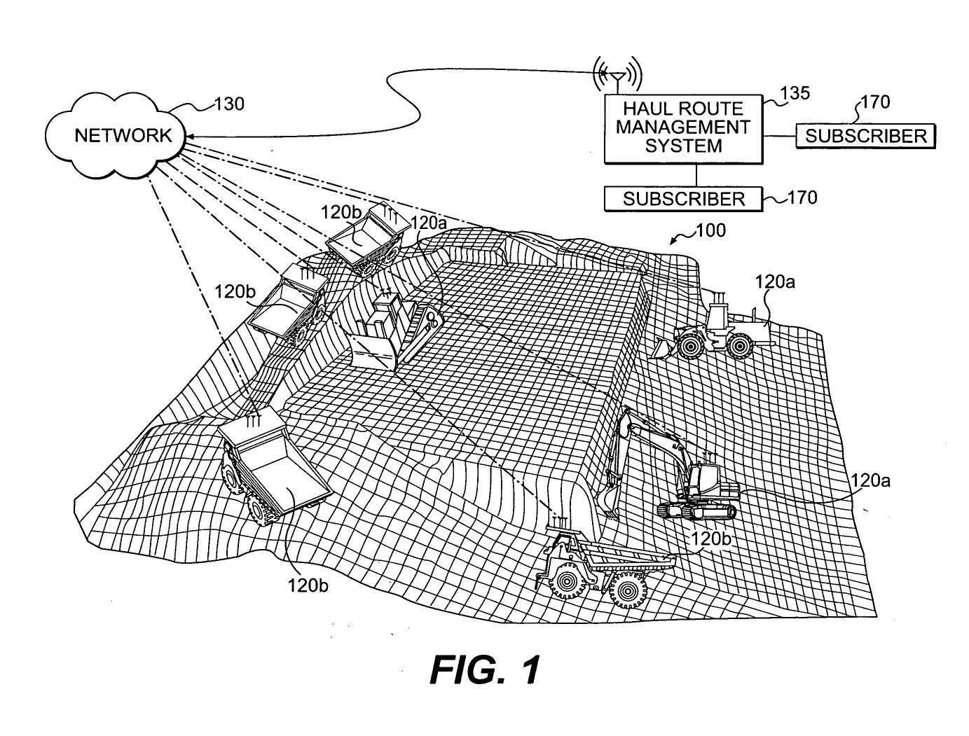

FIG. 1 illustrates an exemplary work environment 100 consistent with the disclosed embodiments. Work environment 100 may include systems and devices that cooperate to perform a commercial or industrial task, such as mining, construction, energy exploration and/or generation, manufacturing, transportation, agriculture, or any task associated with other types of industries. According to the exemplary embodiment illustrated in FIG. 1, work environment 100 may include a mining environment that comprises one or more machines 120a, 120b coupled to a haul route management system 135 via a communication network 130. Work environment 100 may be configured to monitor, collect, and filter information associated with the status, health, and performance of one or more machines 120a, 120b, and distribute the information to one or more back-end systems or entities, such as haul route management system 135 and/or subscribers 170. It is contemplated that work environment 100 may include additional and/or different components than those listed above.

As illustrated in FIG. 1, machines 120a, 120b may include one or more excavators 120a and one or more transport machines 120b. Excavators 120a may embody any machine that is configured to remove material from the mine and load the material onto one or more transport machines 120b. Non-limiting examples of excavators 120a include, for example, bucket-type excavating machines, electromagnetic-lift devices, backhoe loaders, dozers, etc. Transport machines 120b may embody any machine that is configured to transport materials within work environment 100 such as, for example, articulated trucks, dump trucks, or any other truck adapted to transport materials. The number, sizes, and types of machines illustrated in FIG. 1 are exemplary only and not intended to be limiting. Accordingly, it is contemplated that work environment 100 may include additional, fewer, and/or different machines than those listed above. For example, work environment 100 may include skid-steer loader(s), track-type tractor(s), material transfer vehicle(s), or any other suitable fixed or mobile machines that may contribute to the operation of work environment 100.

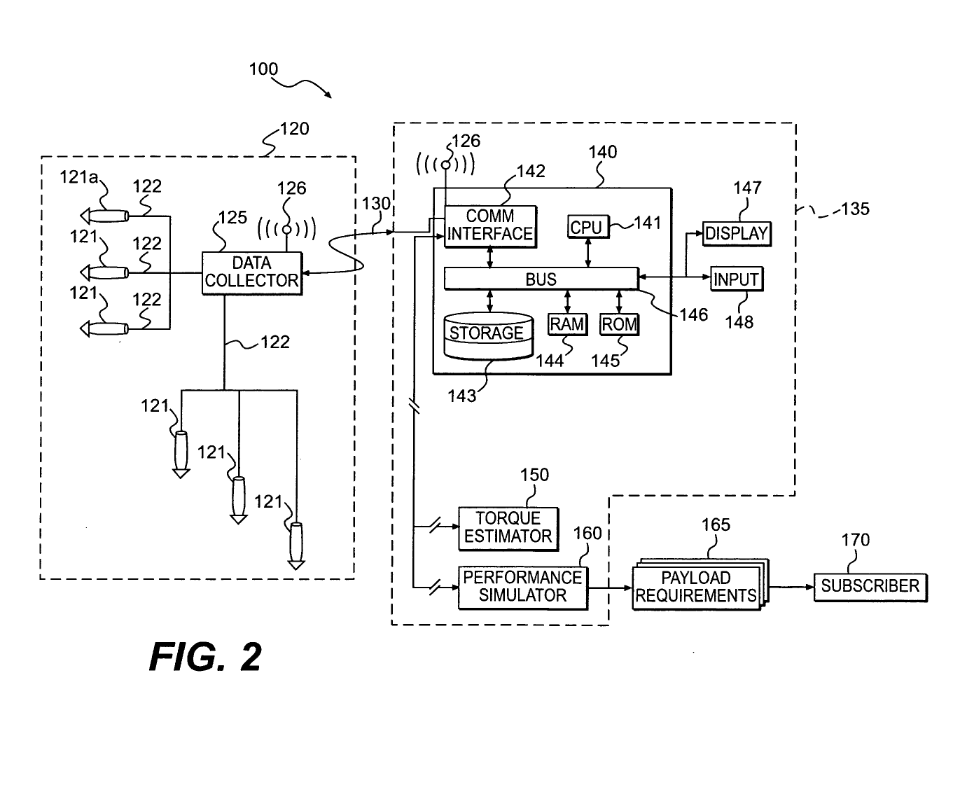

In one embodiment, each of machines 120a, 120b may include on-board data collection and communication equipment to monitor, collect, and/or distribute information associated with one or more components of machines 120a, 120b. As shown in FIG. 2, machines 120a, 120b may each include, among other things, one or more monitoring devices 121, such as sensors and/or electronic control modules coupled to one or more data collectors 125 via communication lines 122; one or more transceiver devices 126; and/or any other components for monitoring, collecting, and communicating information associated with the operation of machines 120a, 120b. Each of machines 120a, 120b may also be configured to receive information, warning signals, operator instructions, or other messages or commands from off-board systems, such as a haul route management system 135. The components described above are exemplary and not intended to be limiting. Accordingly, the disclosed embodiments contemplate each of machines 120a, 120b including additional and/or different components than those listed above.

Monitoring devices 121 may include any device for collecting performance data associated with one or more machines 120a, 120b. For example, monitoring devices 121 may include one or more sensors for measuring an operational parameter such as engine and/or machine speed and/or location; fluid pressure, flow rate, temperature, contamination level, and or viscosity of a fluid; electric current and/or voltage levels; fluid (i.e., fuel, oil, etc.) consumption rates; loading levels (i.e., payload value, percent of maximum payload limit, payload history, payload distribution, etc.); transmission output ratio, slip, etc.; grade; traction data; drive axle torque; intervals between scheduled or performed maintenance and/or repair operations; and any other operational parameter of machines 120a, 120b.

In one embodiment, transport machines 120b may each include at least one torque sensor 121a for monitoring a torque applied to the drive axle. Alternatively, torque sensor 121a may be configured to monitor a parameter from which torque on the drive axle may be calculated or derived.

It is contemplated that one or more monitoring devices 121 may be configured to monitor certain environmental features associated with work environment 100. For example, one or more machines 120a, 120b may include an inclinometer for measuring an actual grade associated with a surface upon which the machine is traveling.

Data collector 125 may be configured to receive, collect, package, and/or distribute performance data collected by monitoring devices 121. Performance data, as the term is used herein, refers to any type of data indicative of at least one operational aspect associated with one or more machines 120a, 120b or any of its constituent components or subsystems. Non-limiting examples of performance data may include, for example, health information such as fuel level, oil pressure, engine temperature, coolant flow rate, coolant temperature, tire pressure, or any other data indicative of the health of one or more components or subsystems of machines 120a, 120b. Alternatively and/or additionally, performance data may include status information such as engine power status (e.g., engine running, idle, off), engine hours, engine speed, machine speed, machine location, current gear that the machine is operating in, or any other data indicative of a status of machines 120a, 120b. Optionally, performance data may also include certain productivity information such as task progress information, load vs. capacity ratio, shift duration, haul statistics (weight, payload, etc.), fuel efficiency, or any other data indicative of a productivity of machines 120a, 120b. Alternatively and/or additionally, performance data may include control signals for controlling one or more aspects or components of machines 120a, 120b.

Data collector 125 may receive performance data from one or more monitoring devices via communication lines 122 during operations of the machine and may transmit the received data to haul route management system 135 via communication network 130. Alternatively or additionally, data collector 125 may store the received data in memory for a predetermined time period, for later transmission to haul route management system 135. For example, if a communication channel between the machine and haul route management system 135 becomes temporarily unavailable, the performance data may be stored in memory for subsequent retrieval and transmission when the communication channel has been restored.

Communication network 130 may include any network that provides two-way communication between machines 120a, 120b and an off-board system, such as haul route management system 135. For example, communication network 130 may communicatively couple machines 120a, 120b to haul route management system 135 across a wireless networking platform such as, for example, a satellite communication system. Alternatively and/or additionally, communication network 130 may include one or more broadband communication platforms appropriate for communicatively coupling one or more machines 120a, 120b to haul route management system 135 such as, for example, cellular, Bluetooth, microwave, point-to-point wireless, point-to-multipoint wireless, multipoint-to-multipoint wireless, or any other appropriate communication platform for networking a number of components. Although communication network 130 is illustrated as a satellite wireless communication network, it is contemplated that communication network 130 may include wireline networks such as, for example, Ethernet, fiber optic, waveguide, or any other type of wired communication network.

Haul route management system 135 may include one or more hardware components and/or software applications that cooperate to improve performance of a haul route by monitoring, analyzing, and/or controlling performance or operation of one or more individual machines. For example, haul route management system 135 may include a condition monitoring system 140 for collecting, distributing, analyzing, and/or otherwise managing performance data collected from machines 120a, 120b. Haul route management system 135 may also include a torque estimator 150 for determining a drive axle torque associated with a machine drive train, estimating a total effective grade of the machine, calculating a total effective grade of the haul road, and/or determining other appropriate characteristics that may be indicative of the performance of a machine or machine drive train. Haul route management system 135 may also include a performance simulator 160 for simulating performance-based models of machines operating within work environment 100 and adjusting operating parameters of machines 120a, 120b and/or physical features of the haul route to improve work environment productivity.

Condition monitoring system 140 may include any computing system configured to receive, analyze, transmit, and/or distribute performance data associated with machines 120a, 120b. Condition monitoring system 140 may be communicatively coupled to one or more machines 120 via communication network 130. Condition monitoring system 140 may embody a centralized server and/or database adapted to collect and disseminate performance data associated with each of machines 120a, 120b. Once collected, condition monitoring system 140 may categorize and/or filter the performance data according to data type, priority, etc. In the case of critical or high-priority data, condition monitoring system 140 may be configured to transmit “emergency” or “critical” messages to one or more work site personnel (e.g., repair technician, project managers, etc.) indicating that a remote asset has experienced a critical event. For example, should a machine become disabled, enter an unauthorized work area, or experience a critical engine operation condition, condition monitoring system 140 may transmit a message (text message, email, page, etc.) to a project manager, job-site foreman, shift manager, machine operator, and/or repair technician, indicating a potential problem with the machine.

Condition monitoring system 140 may include hardware and/or software components that perform processes consistent with certain disclosed embodiments. For example, as illustrated in FIG. 2, condition monitoring system 140 may include one or more transceiver devices 126; a central processing unit (CPU) 141; a communication interface 142; one or more computer-readable memory devices such as storage device 143, a random access memory (RAM) module 144, and a read-only memory (ROM) module 145; a display unit 147; and/or an input device 148. The components described above are exemplary and not intended to be limiting. Furthermore, it is contemplated that condition monitoring system 140 may include alternative and/or additional components than those listed above.

CPU 141 may be one or more processors that execute instructions and process data to perform one or more processes consistent with certain disclosed embodiments. For instance, CPU 141 may execute software that enables condition monitoring system 140 to request and/or receive performance data from data collector 125 of machines 120a, 120b. CPU 141 may also execute software that stores collected performance data in storage device 143. In addition, CPU 141 may execute software that enables condition monitoring system 140 to analyze performance data collected from one or more machines 120a, 120b, perform diagnostic and/or prognostic analysis to identify potential problems with the machine, notify a machine operator or subscriber 170 of any potential problems, and/or provide customized operation analysis reports, including recommendations for improving machine performance.

CPU 141 may be connected to a common information bus 146 that may be configured to provide a communication medium between one or more components associated with condition monitoring system 140. For example, common information bus 146 may include one or more components for communicating information to a plurality of devices. According to one embodiment, CPU 141 may access, using common information bus 146, computer program instructions stored in memory. CPU may then execute sequences of computer program instructions stored in computer-readable medium devices such as, for example, a storage device 143, RAM 144, and/or ROM 145 to perform methods consistent with certain disclosed embodiments, as will be described below.

Communication interface 142 may include one or more elements configured for two-way data communication between condition monitoring system 140 and remote systems (e.g., machines 120a, 120b) via transceiver device 126. For example, communication interface 142 may include one or more modulators, demodulators, multiplexers, demultiplexers, network communication devices, wireless devices, antennas, modems, or any other devices configured to support a two-way communication interface between condition monitoring system 140 and remote systems or components.

One or more computer-readable medium devices may include storage devices 143, a RAM 144, ROM 145, and/or any other magnetic, electronic, flash, or optical data computer-readable medium devices configured to store information, instructions, and/or program code used by CPU 141 of condition monitoring system 140. Storage devices 143 may include magnetic hard-drives, optical disc drives, floppy drives, flash drives, or any other such information storing device. A random access memory (RAM) module 144 may include any dynamic storage device for storing information and instructions by CPU 141. RAM 144 also may be used for storing temporary variables or other intermediate information during execution of instructions to be executed by CPU 141. During operation, some or all portions of an operating system (not shown) may be loaded into RAM 144. In addition, a read only memory (ROM) module 145 may include any static storage device for storing information and instructions by CPU 141.

Condition monitoring system 140 may be configured to analyze performance data associated with each of machines 120a, 120b. According to one embodiment, condition monitoring system 140 may include diagnostic software for analyzing performance data associated with one or more machines 120a, 120b based on threshold levels (which may be factory set, manufacturer recommended, and/or user configured) associated with a respective machine. For example, diagnostic software associated with condition monitoring system 140 may compare an engine temperature measurement received from a particular machine with a predetermined threshold engine temperature for that machine. If the measured engine temperature exceeds the threshold temperature, condition monitoring system 140 may generate an alarm and notify one or more of the machine operator, job-site manager, repair technician, dispatcher, or any other appropriate entity.

In accordance with another embodiment, condition monitoring system 140 may be configured to monitor and analyze productivity associated with one or more of machines 120a, 120b. For example, condition monitoring system 140 may include productivity software for analyzing performance data associated with one or more machines 120a, 120b based on user-defined productivity thresholds associated with a respective machine. Productivity software may be configured to monitor the productivity level associated with each of machines 120a, 120b and generate a productivity report for a project manager, a machine operator, a repair technician, or any other entity that may subscribe to operator or machine productivity data (e.g., a human resources department, an operator training and certification division, etc.) According to one exemplary embodiment, productivity software may compare a productivity level associated with a machine (e.g., amount of material moved by a particular machine) with a predetermined productivity quota established for the respective machine. If the productivity level is less than the predetermined quota, a productivity notification may be generated and provided to the machine operator and/or project manager, indicating the productivity deficiency of the machine. Condition monitoring system 140 may determine and evaluate the productivity of the work environment based on the productivity of the individual machines.

Condition monitoring system 140 may be in data communication with one or more other back-end systems and may be configured to distribute certain performance data to these systems for further analysis. For example, condition monitoring system 140 may be communicatively coupled to a torque estimator 150 and may be configured to provide performance data associated with the machine drive axle to torque estimator 150.

Alternatively or additionally, condition monitoring system 140 may be in data communication with a performance simulator 160 and may be configured to provide performance data to performance simulator 160 for further analysis. Although torque estimator 150 and performance simulator 160 are illustrated as standalone systems that are external to condition monitoring system 140, it is contemplated that one or both of torque estimator 150 and performance simulator 160 may be included as a subsystem of condition monitoring system 140.

Torque estimator 150 may include a hardware or software module configured to receive/collect certain performance data from condition monitoring system 140 and determine, based on the received performance data, a drive axle torque associated with one or more machines 120a, 120b. Torque estimator 150 may be configured to determine a drive axle torque based on performance data collected by torque sensor 121a. Alternatively or additionally, drive axle torque may be estimated based on the performance data and the known design parameters of the machine. For example, based on an engine operating speed and the operating gear, torque estimator 150 may access an electronic look-up table and estimate the drive axle torque of the machine at a particular payload weight using the look-up table.

Once an estimated machine drive axle torque is determined, torque estimator 150 may estimate a total effective grade for the one or more machines. For example, torque estimator 150 may estimate a total effective grade (TEG) value as:

$$T E G = \frac{R P}{G M W} - \frac{M A}{A G} \qquad Equation 1$$

where RP refers to machine rim pull, GMW refers to gross machine weight, MA refers to the acceleration of the machine, and AG refers to the actual grade of the terrain on which that machine is located. Gross machine weight and machine acceleration may be monitored using on-board data monitoring devices 121. Actual grade may be estimated based on monitored GPS data associated with the machine. For example, actual grade may be determined using based on latitude, longitude, and elevation of the machine derived from precision GPS-data gathered from on-board GPS equipment. According to one embodiment, actual grade may be determined by calculating ratio between the vertical change in position (based on the elevation data associated with the GPS data) and the horizontal change in position (based on the latitude and longitude data associated with the GPS data). Alternatively or additionally, actual grade may be calculated using an on-board data monitoring device such as, for example, an inclinometer. Rim pull may be determined as:

$$R P = \frac{D A T \times L P T R \times P T E}{T D R R} \qquad Equation 2$$

where DAT refers to the torque applied to the machine drive axle, LPTR refers to the lower power train reduction factor, PTE refers to the efficiency of the power train, and TDRR refers to the dynamic rolling radius of the tire. Lower power train reduction may be determined by monitoring a change in gear during real-time calculation of rim pull. Power train efficiency may be calculated based on real-time performance data collected from the machine. Tire dynamic rolling radius may be estimated based on a monitored tire pressure, speed, and gross machine weight.

Once total effective grade has been determined, torque estimator 150 may determine a rolling resistance associated with one or more of machines 120a, 120b. A rolling resistance value may be calculated as:

RR=TEG−(AG+EL) Equation 3

where EL refers to the efficiency loss of the machine. Efficiency loss may be estimated as the difference between input power efficiency and output power efficiency, which may be estimated based on empirical test data at particular engine operating speeds and loading conditions. As explained, actual grade may be determined based on calculations associated with collected GPS data and/or monitored using an on-board inclinometer.

Performance simulator 160 may be configured to simulate performance of machines 120a, 120b under various operational or environmental conditions. Based on the simulated performance results, performance simulator 160 may determine one or more machine operating conditions (e.g., speed, gear selection, engine RPM, etc.) and/or haul road parameters (e.g., actual grade, rolling resistance, surface density, surface friction, etc.) to achieve a desired performance of machines 120a, 120b and/or work environment 100.

Performance simulator 160 may be any type of computing system that includes component or machine simulating software. The simulating software may be configured to build an analytical model corresponding to a machine or any of its constituent components based on empirical data collected from real-time operations of the machine. Once the model is built, performance simulator 160 may analyze the model under specific operating conditions (e.g., load conditions, environmental conditions, terrain conditions, haul route design conditions, etc.) and generate simulated performance data of the machine based on the specified conditions.

According to one embodiment, performance simulator 160 may include ideal design models associated with each of machines 120a, 120b. These ideal models can be electronically simulated to generate ideal/design performance data (i.e., data based on the performance of the machine as designed (under ideal operating conditions)). Those skilled in the art will recognize that, as a machine ages, components associated with the machine may begin to exhibit non-ideal behavior, due to normal wear, stress, and/or damage to the machine during operation. In order to provide more realistic performance simulations consistent with these non-idealities, the ideal models may be edited based on actual performance data collected from machines 120a, 120b, thus creating actual or empirical models of a respective machine and/or its individual components.

Performance simulator 160 may also include actual performance-based models associated with each of the machines 120a, 120b. Similar to the ideal design models described above, these performance-based models may be electronically simulated to predict performance and productivity of the machine under a variety of actual operating conditions. However, in contrast with the ideal models described above, performance simulator may be configured to generate the performance-based models based on specific performance data collected from each machine. Performance simulator 160 may simulate an actual model of hauler 120b under a machine operating conditions to determine a speed, torque output, engine condition, fuel consumption rate, greenhouse gas emission level, haul route completion time, etc. associated with each simulated condition. Alternatively or additionally, performance simulator 160 may be configured to simulate the actual model of hauler 120b under a variety of physical conditions (e.g., grade levels, friction levels, smoothness, density, hardness, moisture content, etc.) associated with the haul road surface to identify one or more haul road parameters that cause the one or more machines to operate within a desired threshold operating range. As such, performance simulator 160 may provide mine operators and haul road designers with a solution for customizing a haul road design based on actual performance data associated with one or more machines to be operated thereon.

Performance simulator 160 may be configured to receive haul road parameters associated with perspective haul road design. For example, prior to the design of a haul road for a prospective mine environment, performance simulator 160 may receive one or more haul road parameters from a subscriber 170. Haul road parameters may include any parameter that may be used in designing the haul road such as, for example, a haul road start point (e.g., at an ore depository), a haul road stop point (e.g., at a transport or processing facility), an initial haul road grade, a preliminary haul road route, a haul road budget, or any other parameter that may be defined by subscriber 170 in designing the haul road.

Performance simulator 160 may be configured to allow users to simulate the ideal and/or performance-based software models corresponding with one or more machines under a variety of haul road design conditions. For example, using a software model associated with a hauler, performance simulator 160 may simulate operation of the hauler at multiple haul road grades by varying the total effective grade and/or rolling resistance that is presented to the hauler. Using the equations above, performance simulator may determine an actual grade corresponding to each total effective grade and/or rolling resistance value presented to the hauler and identify trends in machine performance based on road grades associated with one or more haul road designs. Subscribers 170 may select an actual grade for a haul road design by identifying the percent grade at which the simulated performance of the machine exhibits desired performance characteristics. For example, in mine environments where minimizing fuel consumption and/or greenhouse gas emission levels is a priority, performance simulator 160 may identify the haul road grade that causes the machine to consume the least amount of fuel. Alternatively and/or additionally, in mine environments where limiting machine maintenance and repair costs by prolonging component lifespan is critical, performance simulator 160 may identify the haul road grade that produces the least amount of stress and strain forces on the drive train of the machine.

In addition to haul road grade, performance simulator 160 may also be adapted to simulate operation of the hauler under other haul road conditions. For example, rolling resistance may be affected by tire and/or transmission slip, which may each depend upon haul road surface density, moisture level, and friction. Accordingly, performance simulator 160 may simulate performance of one or more machines by varying the rolling resistance level presented to the machine to identify a desired performance level of the machine.

Once a desired machine performance, total effective grade, and/or rolling resistance value associated therewith have been identified, performance simulator 160 may generate one or more haul road designs that comply with the desired machine performance and rolling resistance. For example, performance simulator 160 may specify a particular haul road surface density, friction, and maximum allowable moisture level for one haul road grade that cause the machine to meet the desired machine performance for a particular haul road grade. These parameters may be adjusted depending upon the desired grade level of the machine. Thus, as the grade level increases, thereby increasing the possibility of tire and/or transmission slip, the haul road surface density, friction, and maximum allowable moisture level may be adjusted to compensate for the grade level increase.

Performance simulator 160 may be configured to determine cost/benefit relationships between different haul road designs. For instance, increasing haul road grade may decrease the required length of the haul road, potentially reducing haul road construction and maintenance costs. Increasing the grade of the haul road, however, may result in increased machine maintenance and repair costs, due to the increased stress and strain that may be placed on the machine drive train. Furthermore, because tire and/or transmission slip may be more prevalent on steeper grades, savings in haul road construction costs as a result of the decreased length of the haul road may be offset by increases in costs associated with implementing improvement aimed at reducing slip (e.g., by increasing haul road surface density, increasing haul road drainage to limit excess moisture in the soil, etc.) Performance simulator 160 may compile potential costs/benefits associated with each haul road design.

Performance simulator 160 may also include a diagnostic and/or prognostic simulation tool that simulates actual machine models (i.e., models derived or created from actual machine data) to predict a component failure and/or estimate the remaining lifespan of a particular component or subsystem of the machine. For example, based on performance data associated with the engine and/or transmission, performance simulator 160 may predict the remaining lifespan of the engine, drive train, differential, or other components or subsystems of the machine. Accordingly, performance simulator 160 may predict how changes in one or more haul road parameters may affect the lifespan of one or more of these components. For instance, performance simulator 160 may estimate that, if the grade of a particular haul road segment is reduced by 1.5%, thereby reducing the strain on the engine, transmission, or other drive train components, the remaining lifespan of the drive train may increase by 15%. Performance simulator 160 may periodically report this data to a mine operator, project manager, machine operator, and/or maintenance department of work environment 100.

Performance simulator 160 may be configured to generate payload requirements 165 for one or more machines operating in work environment 100. According to one embodiment, payload requirements 165 may include loading limits for one or more machines 120a, 120b that increase or enhance performance of the one or more machines 120a, 120b and/or work environment 100. For example, performance simulator 160 may identify a machine with an elevated rolling resistance level and determine, based on the performance data associated with the machine, an optimal payload limit for the machine that enables the machine to operate within a threshold range of a target rolling resistance value. Performance simulator 160 may generate payload requirements 165 for the machine that specify the payload limits required to conform to the target rolling resistance goals.

Payload requirements 165 may include paper-based or electronic reports that list machines whose payload levels are modified or prescribed to be lower than a maximum payload level for the machine. Thus, payload requirements 165 may be associated with any machine that performance simulator 160 prescribes to be loaded at less than a maximum loading level associated with the machine. According to one embodiment, payload requirements 165 may be delivered electronically (using email, text message, facsimile, etc.) or via any other appropriate format.

Performance simulator 160 may provide payload requirements 165 to one or more designated subscribers 170 of payload requirement data. Subscribers 170 may include, for example, operators of one or more transport machines 120b listed in the payload requirements 165, operators of one or more machines (e.g., automatic loading machines (conveyor belts, buckets, etc.), excavators 120a, etc.) responsible for loading transport machines 120b, project managers, mine owners, repair technicians, shift managers, human resource personnel, or any other person or entity that may be designated to receive payload requirements 165.

It is contemplated that one or more of condition monitoring system 140, torque estimator 150, and/or performance simulator 160 may be included as a single, integrated software package or hardware system. Alternatively or additionally, these systems may embody separate standalone modules configured to interact or cooperate to facilitate operation of one or more of the other systems. For example, while torque estimator 150 is illustrated and described as a standalone system, separate from performance simulator 160, it is contemplated that torque estimator. 150 may be included as a software module configured to operate on the same computer system as performance simulator 160.

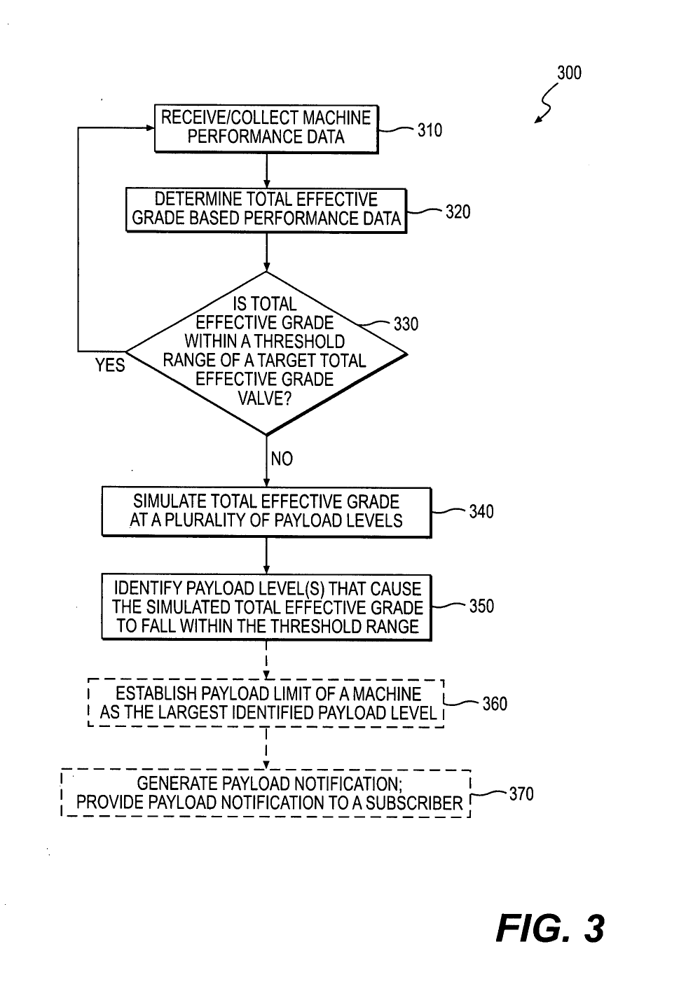

Processes and methods consistent with the disclosed embodiments may enable optimization of a haul route based on real-time performance of one or more machines 120a, 120b operating in work environment 100 by providing a system that combines real-time data monitoring and collection capabilities with performance analysis and simulation tools. Specifically, the features and methods described herein allow project managers, equipment owners, and/or mine operators to effectively identify machines with elevated rolling resistance conditions, analyze performance data associated with these machines to establish or adjust payload limits that regulates the total effective grade and/or rolling resistance of the machines. Optionally, features and methods described herein may be configured to diagnose and/or correct any potential causes of deficient performance. FIG. 3 provides a flowchart 300, which illustrates exemplary performance-based payload regulation methods that may be performed by haul route management system 135.

FIG. 3 illustrates a flowchart 300 depicting an exemplary method for managing machine payloads based on machine performance. As illustrated in FIG. 3, performance data may be collected from at least one machine operating on the haul route (Step 310). For example, condition monitoring system 140 of haul route management system 135 may receive/collect performance data from each machine operating in work environment 100. According to one embodiment, condition monitoring system 140 may automatically receive this data from data collectors 125 associated with each of machines 120a, 120b. Alternatively or additionally, condition monitoring system 140 may provide a data request to each of machines 120a, 120b and receive performance data from each machine in response to the request.

Once machine performance data has been collected, a total effective grade and/or rolling resistance associated with the machine may be determined, based on the machine performance data (Step 320). According to one embodiment, after collection of machine performance data, condition monitoring system 140 may provide drive axle performance data to torque estimator 150. For example, condition monitoring system 140 may deliver drive axle torque data collected from torque sensor 121a to torque estimator 150. Based on the drive axle torque data and other performance data collected by condition monitoring system 140 (e.g., machine weight, machine acceleration, power train efficiency of the machine, dynamic rolling radius of the machine tires, etc.), torque estimator 150 may determine rim pull associated with the machine. Once rim pull is determined, torque estimator 150 may calculate a total effective grade and/or rolling resistance associated with the machine. It is contemplated that torque estimator 150 may be configured to determine total effective grade and/or rolling resistance for each machine in real-time, as condition monitoring system 140 collects performance data during operations of each of machines 120a, 120b.

Machine total effective grade and/or rolling resistance may be compared with a target total effective grade and/or rolling resistance value, respectively (Step 330). For example, torque estimator 150 and/or performance simulator 160 may each be configured to compare the measured rolling resistance value of the machine with a target rolling resistance value. Target rolling resistance, as the term is used herein, refers to a predetermined rolling resistance value that may be established by a user. According to one embodiment, target rolling resistance may include any value selected by the user that defines a rolling resistance associated with a desired performance goal of the machine. For example, target rolling resistance may be established as a rolling resistance value that causes the machine to operate in it's most efficient operating zone. Alternatively or additionally, target rolling resistance may be established as a rolling resistance value that causes the machine to minimize fuel consumption and/or greenhouse gas emission level of the machine. It is contemplated that target rolling resistance may differ for each machine or type of machine and may be determined through empirical testing and/or historical operations of the machine.

In certain situations, a threshold or “buffer” range may be established in connection with the target total effective grade and/or rolling resistance. This may be particularly advantageous to prevent small and/or temporary deviations in machine total effective grade and/or rolling resistance (due to operator error, etc.) from creating an alarm condition. The threshold range may be established by the user as permissible range by which the measured total effective grade and/or rolling resistance can deviate from the target rolling resistance value.

If the measured total effective grade and/or rolling resistance is within a threshold range of the target total effective grade and/or rolling resistance value, respectively (Step 330: Yes) (indicating that the machine is operating within the desired operating range), the process may continue to Step 310 and continue monitoring performance data of the machine. If, on the other hand, the measured total effective grade and/or rolling resistance is not within the threshold range of a target total effective grade and/or rolling resistance value (Step 330: No) (indicating that the machine is operating outside of the desired operating range), performance simulator 160 may simulate machine total effective grade and/or rolling resistance at a plurality of different payload levels (Step 340). For example, if the measured total effective grade and/or rolling resistance is greater than the upper limit of the threshold range of the target total effective grade and/or rolling resistance value, indicating that the machine may be experiencing more resistance on the haul road than is acceptable to maintain the desired performance of the machine, performance simulator 160 may simulate performance of the machine under a plurality of reduced payload conditions.

Performance simulator 160 may identify one or more payload levels that cause the simulated total effective grade and/or rolling resistance to fall within the threshold range (Step 350). According to one embodiment, performance simulator 160 may incrementally reduce payload levels starting with the payload level associated with the non-conforming total effective grade and/or rolling resistance value, simulating performance of the machine at each incremental payload value. Performance simulator 160 may identify the first payload level that causes the simulated total effective grade and/or rolling resistance value to fall within the threshold range of the target total effective grade and/or rolling resistance value.

According to an alternate embodiment, performance simulator 160 may start with an extremely low payload value and incrementally increase the payload value, simulating performance of the machine at each incremental payload value. Performance simulator 160 may identify the first payload level that causes the simulated total effective grade and/or rolling resistance to enter the threshold range of the target total effective grade and/or rolling resistance value.

It is contemplated that performance simulator 160 may be configured to simulate performance of the machine under additional payload levels, even after the detection of a payload level that causes the simulated total effective grade and/or rolling resistance to fall within the threshold range of the target total effective grade and/or rolling resistance value. For example, performance simulator 160 may be configured to simulate performance of the machine under additional payload levels in order to find a total effective grade and/or rolling resistance value that converges on the target total effective grade and/or rolling resistance value.

According to one embodiment, performance simulator 160 may estimate a productivity of the machine at each simulated payload level. Alternatively or additionally, performance simulator 160 may estimate the residual component lifespan for each simulated payload level. The productivity and component lifespan information may be provided as part of a cost/benefit analysis summarized in payload requirements 165 that are provided to subscriber 170. As a result, subscriber 170 may be able to more effectively evaluate how each payload adjustment may affect the productivity and durability of a particular machine.

Once one or more payload levels have been identified, performance simulator 160 may establish a payload limit of the machine, based on the simulated performance data (Step 360). For example, performance simulator 160 may establish the payload limit for the machine as the payload value associated with the simulated total effective grade and/or rolling resistance closest to target total effective grade and/or rolling resistance. Alternatively and/or additionally, in work environments where maximizing productivity is a priority, performance simulator 160 may be configured to establish the payload limit for the machine as the largest payload limit associated with a simulated total effective grade and/or rolling resistance that falls within the threshold range of the target total effective grade and/or rolling resistance.

Performance simulator 160 may be configured to generate a payload requirements 165 and provide the payload requirements to one or more subscribers 170 (Step 370). Payload requirements 165 may embody any type of signal or message notifying subscribers 170 of payload limits associated with one or more machines 120a, 120b. For example, performance simulator 160 may output payload limit data on a display console associated with the machine and any other machine that may be responsible for loading the machine. Alternatively or additionally, performance simulator 160 may provide an electronic message (e.g., page, text message, fax, e-mail, etc.) indicative of the payload limit to a respective machine operator and/or a project manager, haul road dispatcher, excavator and/or loader operator, or any other person or entity established as a subscriber. In response to the payload notifications, subscribers 170 may take appropriate responsive action to limit the payload of each machine to ensure that each machine operates according to a desired performance level.

While certain aspects and features associated with the method described above may be described as being performed by one or more particular components of haul route management system 135, it is contemplated that these features may be performed by any suitable computing system. Furthermore, it is also contemplated that the order of steps in FIG. 3 is exemplary only and that certain steps may be performed before, after, or substantially simultaneously with other steps illustrated in FIG. 3.

### INDUSTRIAL APPLICABILITY

Methods and systems consistent with the disclosed embodiments may provide a haul route management solution that combines real-time equipment monitoring systems with performance-based analysis and simulation tools to identify a target payload level for each machine that improves performance and/or productivity of work environment 100. Work environments that employ processes and features described herein provide an automated system for detecting machines with elevated rolling resistance values and, using performance data collected from each machine during real-time operations of the machines, estimating a payload level to achieve a desired performance goal.

Although the disclosed embodiments are described in connection with work environments involving haul routes for mining operations, they may be applicable to any work environment where it may be advantageous to identify machines that have a negative impact on the productivity of other machines or a fleet of machines. According to one embodiment, the presently disclosed haul route management system and associated methods may be implemented as part of a connected worksite environment that monitors performance data associated with a machine fleet and diagnoses potential problems with machines in the fleet. As such, the haul route management system may enable both health and productivity monitoring of a work environment using real-time performance data associated with the one or more machines.

The presently disclosed systems and methods for performance-based payload management may have several advantages. For example, the systems and methods described herein provide a solution for responsively adjusting machine payload levels based on changes in machine rolling resistance. Because machine payload may be adjusted quickly and easily by notifying work environment personnel prior to loading the machine, work environments that rely on responsive performance adjustments to maximize productivity of the haul road may become more efficient than conventional systems that rely on re-designing haul road segments to reduce rolling resistance.

In addition, the presently disclosed performance-based payload management system may have significant cost advantages. For example, by providing a system that detects deviations in rolling resistance associated with one or more machines and responsively modifies machine payload levels in order to meet target rolling resistance levels, a desired machine performance level may be achieved without requiring expensive or invasive modifications to the haul road, as required by some conventional systems.

It will be apparent to those skilled in the art that various modifications and variations can be made to the disclosed system and method for performance-based payload management without departing from the scope of the disclosure. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for managing machine payload based on haul road conditions, the method comprising:
collecting performance data associated with a machine operating in a work environment;
determining an actual total effective grade of the machine based on the collected performance data;
comparing the actual total effective grade with a target total effective grade value;
simulating total effective grade at a plurality of payload levels if the actual total effective grade is not within a threshold range of the target total effective grade value; and
identifying at least one of the plurality of payload levels that causes the simulated total effective grade to fall within the threshold range of the target total effective grade value.

2. The method of claim 1, further including establishing a payload limit of the machine as the largest payload level of the at least one of the plurality of payload levels.

3. The method of claim 2, further including:
generating a payload notification indicative of the payload limit for the machine; and
providing the payload notification to a payload subscriber.

4. The method of claim 1, further including outputting the simulated total effective grade data.

5. The method of claim 1, wherein simulating total effective grade includes:
generating a software model of the machine based on the collected performance data; and
simulating operation of the machine using the generated software model.

6. The method of claim 1, further including determining a productivity level of the machine for each of the plurality of payload levels.

7. The method of claim 1, further including estimating a lifespan associated with one or more drive train components of the machine for each of the plurality of payload levels.

8. A computer-readable medium for use on a computer system, the computer-readable medium including computer-executable instructions for performing a method for managing machine payload based on haul road conditions, the method comprising:
collecting performance data associated with a machine operating in a work environment;
determining an actual total effective grade of the machine based on the collected performance data;
comparing the actual total effective grade with a target total effective grade value;
simulating total effective grade at a plurality of payload levels if the actual total effective grade is not within a threshold range of the target total effective grade value; and
identifying at least one of the plurality of payload levels that causes the simulated total effective grade to fall within the threshold range of the target total effective grade value.

9. The computer-readable medium of claim 8, wherein the method further includes establishing a payload limit of the machine as the largest payload level of the at least one of the plurality of payload levels.

10. The computer-readable medium of claim 9, wherein the method further includes:
generating a payload notification indicative of the payload limit for the machine; and
providing the payload notification to a payload subscriber.

11. The computer-readable medium of claim 8, wherein the method further includes outputting the simulated total effective grade data.

12. The computer-readable medium of claim 8, wherein simulating total effective grade includes:
generating a software model of the machine based on the collected performance data; and
simulating operation of the machine using the generated software model.

13. The computer-readable medium of claim 8, wherein the method further includes determining a productivity level of the machine for each of the plurality of payload levels.

14. The computer-readable medium of claim 8, wherein the method further includes estimating a lifespan associated with one or more drive train components of the machine for each of the plurality of payload levels.

15. A haul route management system comprising:
a condition monitoring system in data communication with a machine operating in a work environment and configured to:
collect performance data associated with a machine operating in the work environment; and
monitor an actual total effective grade of the machine based on the performance data;
a performance simulator communicatively coupled to the condition monitoring system and configured to:
compare the actual total effective grade with a target total effective grade value;
simulate total effective grade associated with a plurality of payload levels if the actual total effective grade is not within a threshold range of the target total effective grade value; and
identify at least one of the plurality of payload levels that causes the simulated total effective grade to fall within the threshold range of the target total effective grade value.

16. The system of claim 15, wherein the performance simulator is further configured to establish a payload limit of the machine as the largest payload level of the at least one of the plurality of payload levels that causes the simulated total effective grade to fall within the threshold range of the target total effective grade value.

17. The system of claim 15, wherein the performance simulator is further configured to output the simulated total effective grade data.

18. The system of claim 15, wherein the performance simulator is further configured to:
generate a payload notification indicative of the payload limit for the machine; and
provide the payload notification to a payload subscriber.

19. The system of claim 15, wherein simulating total effective grade includes:
generating a model of the machine based on the collected performance data; and
simulating operation of the machine using the generated model.

20. The system of claim 15, wherein the performance simulator is further configured to determine a productivity level of the machine for each of the plurality of payload levels.

21. The system of claim 15, wherein the performance simulator is further configured to estimate a lifespan associated with one or more drive train components of the machine for each of the plurality of payload levels.
